(19) United States
(12) Patent Application Publication
(10) Pub. No.: US 2016/0217565 A1
(43) Pub. Date: Jul. 28, 2016

(54) Health and Fitness Monitoring via Long-Term Temporal Analysis of Biometric Data

(71) Applicant: Sensory, Incorporated, Santa Clara, CA (US)

(72) Inventors: Todd F. Mozer, Los Altos, CA (US); Bryan Pellom, Erie, CO (US)

(21) Appl. No.: 14/607,833

(22) Filed: Jan. 28, 2015

(51) Int. Cl. G06T 7/00; G06F 17/30; G06K 9/00

(52) U.S. Cl. CPC G06T 7/0012; G06K 9/00255; G06K 9/00281; G06K 9/00288; G06F 17/3028; G06K 9/00362; G06T 2207/30201

(57) ABSTRACT

Techniques for performing health and fitness monitoring via long-term temporal analysis of biometric data are provided. In one embodiment, a computing device can receive biometric data for a user that is captured via a biometric authentication system. The computing device can further extract one or more features from the biometric data pertaining to the user's health, fitness, or personal appearance and can analyze the one or more features in view of previous features extracted from previous biometric data for the user. The computing device can then determine a health or fitness status (or change in status) of the user based on that analysis.

### BACKGROUND

In recent years, mobile wearable devices (referred to herein as “wearables”) have become popular for tracking and assessing wearer health and/or fitness. Examples of such wearables include smartwatches, smart armbands, smart wristbands, and the like. Consumer products in this area have been driven by advances in low-power motion and heart rate sensing, which allow for the measurement of, e.g., the number of steps taken, distance traveled, and even the number of calories burned during a workout. Some wearables can also measure the sleep patterns of an individual by combining heart rate sensing and motion sensing.

In addition to advances in the area of health and fitness wearables, significant advances have also been made in the area of face and voice biometrics for mobile and wearable device authentication. Applications of this technology have been developed that enable a user to, e.g., unlock the home screen of his/her device or unlock the launching of specific mobile applications using his/her face or voice. Face and voice-based biometric authentication provide simpler and more secure alternatives to password-based authentication, since the user no longer needs to keep track of complicated passwords (which can be compromised through a variety of methods or circumstances). Face and voice-based biometric authentication also allow for authentication on devices that may be too small to provide a keyboard for password or PIN entry.

Unfortunately, the authentication solutions that leverage face and voice biometrics today are largely sole-purposed. Specifically, these existing solutions capture an image of a user's face and/or audio of the user's voice and then perform an instantaneous evaluation of the captured biometric data to decide on the user's identity. No further use of this biometric data is made, despite the fact that face and voice signals, particularly when analyzed over time, contain a wealth of cues related to the health and fitness of the user.

### SUMMARY

Techniques for performing user health and fitness monitoring via long-term temporal analysis of biometric data are provided. In one embodiment, a computing device can receive biometric data for a user that is captured via a biometric authentication system. The computing device can further extract one or more features from the biometric data pertaining to the user's health, fitness, or personal appearance and can analyze the one or more features in view of previous features extracted from previous biometric data for the user. The computing device can then determine a health or fitness status (or change in status) of the user based on that analysis.

A further understanding of the nature and advantages of the embodiments disclosed herein can be realized by reference to the remaining portions of the specification and the attached drawings.

### BRIEF DESCRIPTION OF THE DRAWINGS

FIG. 1 depicts a system environment according to an embodiment.

FIG. 2 depicts a flowchart for performing health/fitness monitoring via long-term temporal analysis of biometric data according to an embodiment.

FIG. 3 depicts a flowchart for using a health/fitness status determined via the flowchart of FIG. 2 to trigger one or more predefined actions according to an embodiment.

FIG. 4 depicts an exemplary computing device according to an embodiment.

### DETAILED DESCRIPTION

In the following description, for purposes of explanation, numerous examples and details are set forth in order to provide an understanding of specific embodiments. It will be evident, however, to one skilled in the art that certain embodiments can be practiced without some of these details, or can be practiced with modifications or equivalents thereof.

### 1. Overview

The present disclosure describes techniques for monitoring the heath and/or fitness of a user by performing long-term temporal analysis of biometric data (e.g., face data, voice data, ECG-based heart monitor data, etc.) that is captured via a biometric authentication system/subsystem. By way of example, assume that the user operates a mobile computing device, such as a smartphone, tablet, smartwatch, or the like. Further assume that the user authenticates himself/herself on a periodic basis with a face or voice-based authentication subsystem of the mobile computing device (for the purpose of, e.g., accessing data or applications) by providing face or voice data to the subsystem. In this and other similar scenarios, the mobile computing device (or another computing device/system in communication with the mobile computing device) can leverage the biometric data that is captured from the user at each authentication event in order to monitor the user's health, fitness, and/or personal appearance over time.

For instance, in one set of embodiments, a health analysis subsystem running on the mobile computing device (or another device/system) can extract, from the biometric data captured at a particular authentication event, features that are relevant to the user's health, fitness, and/or personal appearance. Examples of such features can include the color/shape around the user's eye and nasal regions, the shape/size of the user's chin and cheek, the color and uniformity of the user's skin, the pitch of the user's voice, and so on (further examples are provided below). The health analysis subsystem can analyze these extracted health/fitness features in view of similar features that were previously extracted from biometric data captured from the same user at previous authentication events. In this way, the health analysis subsystem can determine how those features have changed over time (which may indicate an increase/decline in fitness or the onset/passing of an illness). The health analysis subsystem can then determine a current health and/or fitness status (or change in status) for the user based on the analysis, update a health/fitness profile for the user using the determined status (or create one if no such profile exists), and store the extracted health/fitness features for future analyses.

With the general approach described above, the techniques of the present invention can take advantage of the wealth of health/fitness cues found face, voice, and other biometric data to help individuals keep track of and manage their well-being. At the same time, these techniques do not require any explicit user action for data collection; instead, they make use of biometric data that is already captured from users as part of existing authentication workflows. Accordingly, these techniques can be significantly less burdensome for users than alternative methods that may require, e.g., explicit user enrollment of face or voice data on a periodic basis.

These and other features of the present invention are described in further detail in the sections that follow.

### 2. System Environment

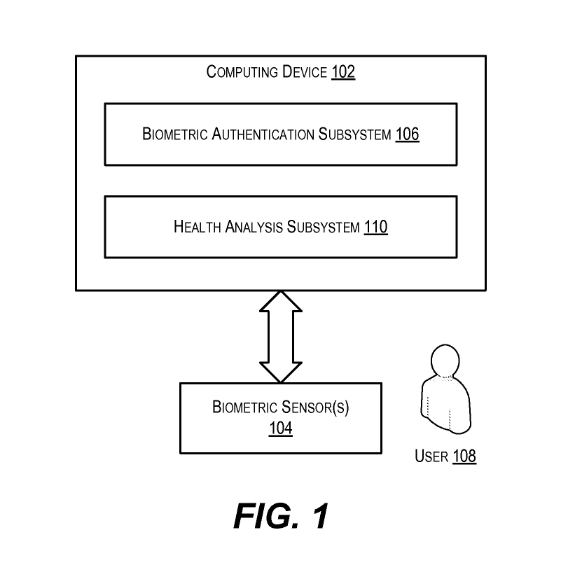

FIG. 1 depicts a high-level system environment 100 according to an embodiment. As shown, system environment 100 includes a computing device 102 that is communicatively coupled to one or more biometric sensors 104. In one set of embodiments, computing device 102 can be a mobile device, such as a smartphone, a tablet, or a wearable device (e.g., smartwatch, smart armband/wristband, etc.). Computing device 102 can also be any other type of electronic device, such as a desktop or server computer system, laptop, set-top or home automation/security box, or the like.

Biometric sensors 104 can comprise any type or combination of sensors/devices that are operable for capturing biometric data, such as a camera (for capturing images of a user's face), a microphone (for capturing audio of a user's voice), an ECG monitoring device (for capturing electrical activity of the heart), and so on. In some embodiments, biometric sensors 104 can be integrated into computing device 102. For example, in a scenario where computing device 102 is a smartphone or smartwatch, biometric sensors 104 can comprise cameras, microphones, etc. that are built into the device. In other embodiments, biometric sensors 104 may be resident in another device or housing that is separate from computing device 102. For example, in a scenario where computing device 102 is a home automation or security device, biometric sensors 104 may be resident in a home fixture, such as a front door, a bathroom minor, or the like. In this and other similar scenarios, biometric data captured via sensors 104 can be relayed to computing device 100 via an appropriate communication link (e.g., a wired or wireless link).

In addition to computing device 102 and biometric sensors 104, system environment 100 includes a biometric authentication subsystem 106 (in this example, running on computing device 102). Generally speaking, biometric authentication subsystem 106 can receive biometric data captured from a user 108 via biometric sensors 104, convert the biometric data into a computational format (e.g., illumination-corrected texture features in the case of face data, cepstral coefficients in the case of voice data, etc.), compare the converted biometric data against user enrollment data, and determine, based on that comparison, whether the identity of user 108 can be verified. If so, user 108 is authenticated and allowed to perform an action that would otherwise be restricted (e.g., unlock the device home screen, access/launch certain applications, unlock the front door, etc.). In one embodiment, biometric authentication system 106 can be a face-based system and can operate on biometric data corresponding to face images. In another embodiment, biometric authentication system 106 can be a voice-based system and can operate on biometric data corresponding to voice audio signals. In another embodiment, biometric authentication system 106 can be a heart-based system and can operate on biometric data corresponding to ECG-based heart monitor signals. In yet another embodiment, biometric authentication system 106 can be a combination system and can operate on biometric data corresponding to different types of biometric data (e.g., face, voice, heart, etc.).

As noted previously, biometric data like the face and/or voice data processed by biometric authentication system 106 can contain a wealth of information regarding the health, fitness, and personal appearance of an individual, particularly when evaluated over time. For instance, a user's face can show signs of lack of sleep (e.g., redness and swollen eyes, dark circles around the eyes, droopy eyelids) when compared to a well-rested state; a user's face/voice can change due to illness (e.g., when a cold is present, the nasal area may become reddened/swollen and the voice can become creaky); and a user's chin and cheek regions can change in size and shape due to weight gain or weight loss. Unfortunately, in conventional biometric authentication solutions, the biometric data collected/determined at the time of an authentication event is used solely for user verification purposes and then discarded.

To better take advantage of these valuable health/fitness cues, system environment 100 also includes a novel health analysis subsystem 110. Although health analysis subsystem 110 is shown as being a part of computing device 102, in alternative embodiments health analysis subsystem 110 can run, either entirely or partially, on another system or device that is communicatively coupled with computing device 102, such as a remote/cloud-based server. As described in detail below, health analysis subsystem 110 can keep track of the biometric data captured from user 108 via biometric authentication subsystem 106 as part of subsystem 106′s conventional authentication workflow. Health analysis subsystem 110 can then perform a temporal analysis of this data, thereby allowing the subsystem to determine how user 108′s health, fitness, and even aesthetic appearance change over time.

In certain embodiments, health analysis subsystem 110 can use the determined health/fitness status information to inform a broader health/fitness profile for user 108. In other embodiments, health analysis subsystem 110 can use the determined health/fitness status information to trigger one or more actions based upon predefined criteria/rules. An example of such an action is alerting the user or a third party, like the user's doctor, to a health condition that requires attention (e.g., a potentially dangerous illness, etc.). Thus, in these embodiments, health analysis subsystem 110 can take an active role in helping user 108 manage his/her health and fitness.

It should be appreciated that system environment 100 of FIG. 1 is illustrative and not intended to limit embodiments of the present invention. For instance, as mentioned above, biometric authentication subsystem 106 and health analysis subsystem 110 of computing device 102 can be configured to run, either entirely or partially, on a separate device/system. In addition, the components of system environment 100 can include other subcomponents or features that are not specifically described/shown. One of ordinary skill in the art will recognize many variations, modifications, and alternatives.

### 3. Health Analysis Subsystem Workflow

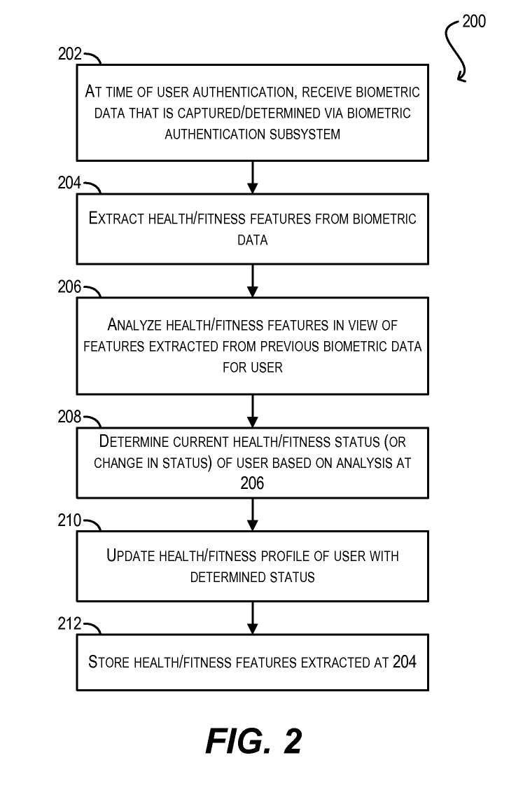

FIG. 2 depicts a high-level workflow 200 that can be carried out by health analysis subsystem 110 of FIG. 1 for performing health/fitness monitoring according to an embodiment. Starting with block 202, at the time of authenticating a user (e.g., user 108), health analysis subsystem 110 can receive biometric data that is captured/determined by biometric authentication subsystem 106 as part of the authentication process. In embodiments where biometric authentication subsystem 106 is based on face recognition, the received biometric data can comprise images of user 108's face (and/or facial features determined by subsystem 106 for the purpose of authentication). In these embodiments, the face images can comprise standard, two-dimensional photographs. Alternatively (depending on the nature of the camera(s) used to capture the images), the face images can comprise three-dimensional, ultraviolet, and/or infrared imagery.

In embodiments where biometric authentication subsystem 106 is based on voice recognition, the received biometric data can comprise audio of the user's voice (and/or voice features determined by subsystem 106 for the purpose of authentication). And in embodiments where biometric authentication subsystem 106 is based on a combination of face and voice recognition, the received biometric data can include both face images and voice audio.

At block 204, health analysis subsystem 110 can extract features pertaining to user 108's health, fitness, and/or personal appearance from the received biometric data. These health/fitness features can include, e.g., features that may indicate an illness, features that may indicate lack of sleep, features that may indicate a change in weight, features that may indicate general changes in aesthetic appearance, and so on. For example, with respect to voice data, features that may indicate an illness can include vocal creakiness, hoarseness, or nasality. With respect to facial data, features that may indicate an illness can include the color/shape of the user's nasal region, the color/shape of the user's eyes, skin color irregularities, and facial shape irregularities; features that may indicate a lack of sleep can include the color/shape of the user's eye regions and droopy eyelids; features that may indicate a change in weight can include the color/shape of the user's chin and cheek regions; and features that may indicate general changes in aesthetic appearance cam include hair length and color (on the head or face), wrinkles, the absence/presence of makeup. and facial symmetry. It should be appreciated that these features are merely provided as examples, and that other types of health/fitness-related cues in voice or facial biometric data will be evident to one of ordinary skill in the art.

Once the health/fitness features have been extracted from the received biometric data, health analysis subsystem 110 can analyze the extracted features in view of previous instances of the same features (for the same user 108) extracted during previous authentication events (block 206). For instance, as part of this processing, health analysis subsystem 110 can retrieve (from, e.g., a database associated with user 108) health/fitness features for the user extracted from biometric data captured over the past 10, 100, 1000 or more authentication events (or over a designated period of time). Health analysis subsystem 110 can then compare the current health/fitness features of user 108 with the historical features, thereby allowing the subsystem to model how the features have changed over time. Health analysis subsystem 110 can use any of a number of known machine learning techniques to perform this processing, such as neural networks, decision trees, etc. In embodiments where the heath/fitness features are extracted from two different types of biometric data (e.g., face and voice data), health analysis subsystem 110 can analyze the two types of features separately or together. Further, in some embodiments, the features extracted from one type of biometric data may be given different weight that features extracted from another type of biometric data based on a variety of factors (e.g., environmental conditions at the time of data capture, etc.).

Upon completing the analysis at block 206, health analysis subsystem 110 can determine a current health/fitness status (or change in status) for user 108 (block 208). For example, if the analysis at block 206 indicates that the user's nasal regions have become more swollen or become more red when compared to previous facial data, health analysis subsystem 110 may determine that user 108 is currently suffering from a cold. As another example, if the analysis at block 206 indicates a growing or new skin lesion, health analysis subsystem 110 may determine that user 108 has possibly developed skin cancer. As yet another example, if the analysis at block 206 indicates that user 108′s cheek and chin regions have decreased in size, health analysis subsystem 110 may determine that user 108 has lost weight.

At block 210, health analysis subsystem 110 can update a health and fitness profile for user 108 based on the current status determined at block 208. If such a profile does not yet exist, health analysis subsystem 110 can create a new profile for the user and initialize it with the current status information. Finally, at block 212, health analysis subsystem 110 can store (in, e.g., the database associated with user 108) the health/fitness features extracted at block 204 so that those features can be used as historical data in future analyses.

### 4. Triggering Actions Based on Health/Fitness Status

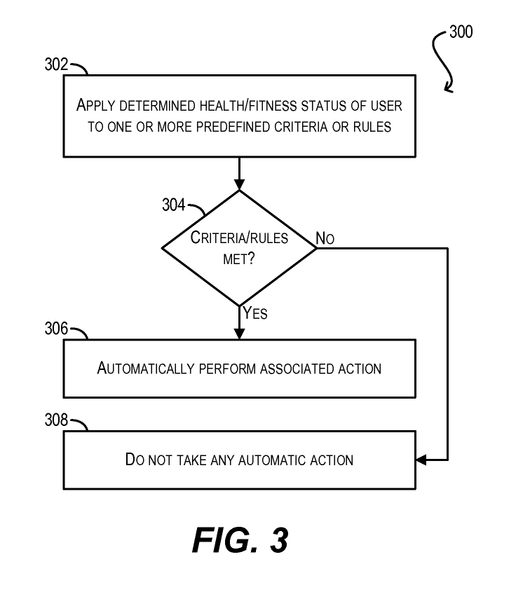

In certain embodiments, in addition to updating a user's health and fitness profile, health analysis subsystem 110 can also use the determined health/fitness status as a trigger for performing one or more actions, such as alerting the user (or a third party) that an action should be taken. In this manner, health analysis subsystem 110 can more proactively aid the user in managing his/her health and physical appearance. FIG. 3 depicts a flowchart 300 of such a processing flow according to an embodiment. Flowchart 300 assumes that workflow 200 of FIG. 2 has been performed and that a current health/fitness status for user 108 has been determined.

Starting with block 302, health analysis subsystem 110 can apply the health/fitness status determined for user 108 at block 208 of FIG. 2 to one or more predefined criteria or rules. For instance, one such criterion/rule may look for skin spots that exceed a certain size (indicating cancer). Another type of criterion/rule may look at hair length (indicating that the user is due for a haircut). In various embodiments, some or all of the criteria/rules can be configurable by the user.

At block 304, health analysis subsystem 110 can determine whether the current status causes any of the criteria/rules to be met. If not, subsystem 110 can take no action (block 308).

However, if health analysis subsystem 110 determines that a particular criterion/rule has been met, subsystem 110 can then automatically perform an action associated with the criterion/rule (block 306). As noted previously, one example of such an action is alerting user 108 and/or a third party (e.g., the user's doctor) to a condition that requires attention. This may be a serious health condition (e.g., cancer), or simply an aesthetic condition (e.g., the user's hair has grown too long and thus is due for a haircut). The alert itself can take different forms, such as a popup notification (if subsystem 110 is running on the user's mobile device), an email, etc. Another example of such an action is automatically ordering medication for user 108 if health analysis subsystem 110 determines that the user has come down with an illness (e.g., a cold, eye infection, etc.). Yet another example of such as action is recommending lifestyle changes to user 108 in order to improve his/her fitness (if, e.g., health analysis subsystem 110 determines that user 108 has gained weight). One of ordinary skill the art will recognize other variations, modifications, and alternatives.

### 5. Example Implementations

As discussed with respect to system environment 100 of FIG. 1, embodiments of the present invention can be implemented in different contexts and according to different configurations. For example, in one set of embodiments, biometric authentication subsystem 106 and health analysis subsystem 110 can both run on a user's mobile or wearable device. In these embodiments, the mobile/wearable device can collect user biometric data via sensors 104 integrated into the device (e.g., a device camera or microphone), and can pass the data to biometric authentication subsystem 106 to verify the user. Once the user is verified, biometric authentication subsystem 106 can then pass the biometric data (as well as any other characteristics determined by the authentication subsystem) to health analysis subsystem 110 for processing in accordance with workflow 200 of FIG. 2. This can be considered a “local” implementation since all processing is performed on the user's local mobile/wearable device.

In another set of embodiments, some (or all) of the processing attributed to health analysis subsystem 110 may be performed on a remote server that is separate from the user's local device (e.g., a cloud-based server hosted by a service provider). In these embodiments, the user's local device (which may still run biometric verification subsystem 106) can send the user's biometric data to the remote server for health/fitness analysis. The user may then be able to access his/her health and fitness profile via a device application that communicates with the remote server, or via a web-based portal.

In yet another set of embodiments, rather that integrating biometric sensors 104 into the user's local computing device, biometric sensors 106 may be implemented at a location that is separate from the user's device. For example, in a particular embodiment, biometric sensors 104 may be implemented in the user's front door, a bathroom minor, or another location where the user is likely to present his/her face. This increases the likelihood that the system will be able to capture image of the user's face on a regular basis for health and fitness tracking.

### 6. Exemplary Computer Device

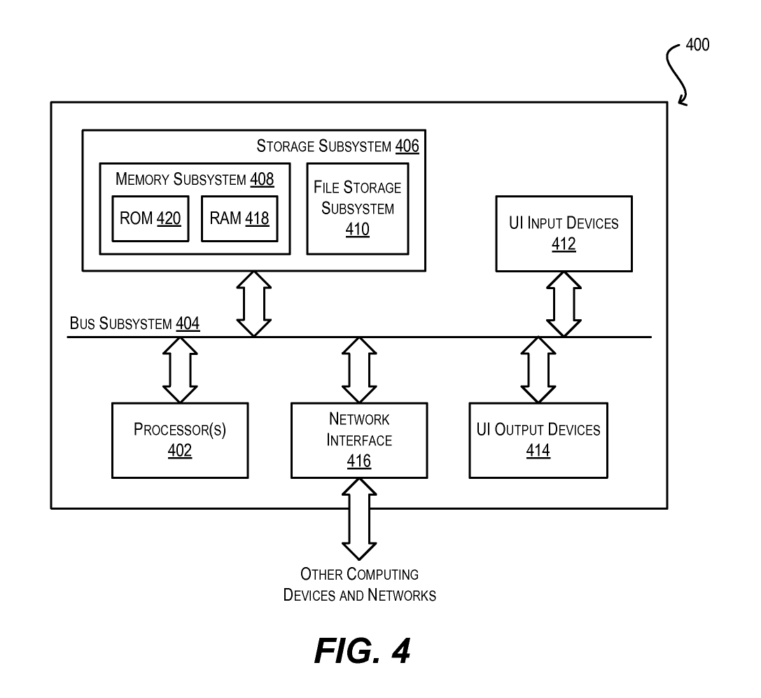

FIG. 4 is a simplified block diagram of a computing device 400 that may be used to implement the foregoing embodiments of the present invention. In particular, device 400 can be used to implement computing device 100 of FIG. 1. As shown, computing device 400 includes one or more processors 402 that communicate with a number of peripheral devices via a bus subsystem 404. These peripheral devices include a storage subsystem 406 (comprising a memory subsystem 408 and a file storage subsystem 410), user interface input devices 412, user interface output devices 414, and a network interface subsystem 416.

Bus subsystem 404 provides a mechanism for letting the various components and subsystems of computing device 400 communicate with each other as intended. Although bus subsystem 404 is shown schematically as a single bus, alternative embodiments of the bus subsystem can utilize multiple busses.

Network interface subsystem 416 serves as an interface for communicating data between computing device 400 and other computing devices or networks. Embodiments of network interface subsystem 416 can include wired (e.g., coaxial, twisted pair, or fiber optic Ethernet) and/or wireless (e.g., Wi-Fi, cellular, Bluetooth, etc.) interfaces.

User interface input devices 412 can include a touch-screen incorporated into a display, a keyboard, a pointing device (e.g., mouse, touchpad, etc.), an audio input device (e.g., a microphone), and/or other types of input devices. In general, use of the term “input device” is intended to include all possible types of devices and mechanisms for inputting information into computing device 400.

User interface output devices 414 can include a display subsystem (e.g., a flat-panel display), an audio output device (e.g., a speaker), and/or the like. In general, use of the term “output device” is intended to include all possible types of devices and mechanisms for outputting information from computing device 400.

Storage subsystem 406 includes a memory subsystem 408 and a file/disk storage subsystem 410. Subsystems 408 and 410 represent non-transitory computer-readable storage media that can store program code and/or data that provide the functionality of various embodiments described herein.

Memory subsystem 408 can include a number of memories including a main random access memory (RAM) 418 for storage of instructions and data during program execution and a read-only memory (ROM) 420 in which fixed instructions are stored. File storage subsystem 410 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computing device 400 is illustrative and not intended to limit embodiments of the present invention. Many other configurations having more or fewer components than computing device 400 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims.

For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted.

Further, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a computing device, biometric data for a user captured via a biometric authentication system;
extracting, by the computing device, one or more features from the biometric data pertaining to the user's health, fitness, or personal appearance;
analyzing, by the computing device, the one or more features in view of previous features extracted from previous biometric data for the user; and
determining, by the computing device, a health or fitness status or change in status of the user based on the analyzing.

2. The method of claim 1 further comprising:
storing the one or more features in a database associated with the user, the database containing the previous features extracted from the previous biometric data; and
updating a health or fitness profile for the user based on the determined status or change in status.

3. The method of claim 1 wherein the biometric data includes face data.

4. The method of claim 3 wherein the one or more features extracted from the biometric data pertain to coloring, texture, size, or quantity.

5. The method of claim 3 wherein the one or more features extracted from the biometric data include features that may indicate an illness or a potential medical condition.

6. The method of claim 5 wherein the features that may indicate an illness or potential medical condition include color or shape of the user's nose, ears, eyes, or mouth, skin color irregularities, facial shape irregularities, appearance of new markings, shapes of such markings, and timing and rapidity of onset of such markings.

7. The method of claim 3 wherein the one or more features extracted from the biometric data include features that may indicate a lack of sleep.

8. The method of claim 7 wherein the features that may indicate a lack of sleep include color or shape around the user's eye regions.

9. The method of claim 3 wherein the one or more features extracted from the biometric data include features that may indicate an increase or decrease in weight.

10. The method of claim 9 wherein the features that may indicate an increase or decrease include chin and cheek size.

11. The method of claim 3 wherein the one or more features extracted from the biometric data include features pertaining to the user's aesthetic appearance.

12. The method of claim 11 wherein the features pertaining to the user's aesthetic appearance include hair length, wrinkles, the absence or presence of makeup, and facial symmetry.

13. The method of claim 3 wherein the face data is based on ultraviolet or infrared images of the user's face.

14. The method of claim 3 wherein the face data is based on three dimensional images of the user's face.

15. The method of claim 3 wherein the biometric data further includes voice data.

16. The method of claim 1 further comprising:
applying the determined health or fitness status or change in status of the user to one or more predefined criteria or rules; and
if the one or more predefined criteria or rules are met, automatically performing an associated action.

17. The method of claim 16 wherein the associated action comprises alerting the user or a third party of the determined status or change in status.

18. The method of claim 17 wherein the associated action further comprises providing a recommendation to the user.

19. The method of claim 16 wherein the one or more predefined criteria or rules are configurable by the user.

20. The method of claim 1 wherein the computing device is smartphone or tablet, and wherein the biometric authentication system captures the biometric data from the user for authentication purposes each time the user attempts gain access to the device or certain resources on the device.

21. A non-transitory computer readable medium having stored thereon program code executable by a processor, the program code comprising:
code that causes the processor to receive biometric data for a user captured via a biometric authentication system;
code that causes the processor to extract one or more features from the biometric data pertaining to the user's health, fitness, or personal appearance;
code that causes the processor to analyze the one or more features in view of previous features extracted from previous biometric data for the user; and
code that causes the processor to determine a health or fitness status or change in status of the user based on the analyzing.

22. A mobile computing device comprising:
a biometric authentication subsystem; and
a health analysis subsystem,
wherein the health analysis subsystem is configured to:
receive biometric data for a user, the biometric data being captured by the biometric authentication subsystem at a time of user authentication;
extract one or more features from the biometric data pertaining to the user's health, fitness, or personal appearance;
analyze the one or more features in view of previous features extracted from previous biometric data for the user; and
determine a health or fitness status or change in status of the user based on the analyzing.
